(19) United States
(12) Patent Application Publication
(10) Pub. No.: US 2006/0219849 A1
(43) Pub. Date: Oct. 5, 2006

(54) Height-adjustable support for a display device

(75) Inventor: Posen Chiu, Pan-Chiao City (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Fulfil Tech. Co., Ltd.

(21) Appl. No.: 11/252,127

(22) Filed: Oct. 17, 2005

(30) Foreign Application Priority Data
Apr. 4, 2005 (TW) 094205193

(51) Int. Cl. F16M 11/00

(52) U.S. Cl. 248/125.8; 248/917; 361/681

(57) ABSTRACT

A height-adjustable support for a display panel includes a base, a telescopic unit, an angle-adjustable member, a coupling unit, and a control member. The telescopic unit includes a hollow outer member and an inner slide member. The outer member extends upwardly from the base, and is provided with an upper limiting part disposed above the base, and an inwardly projecting lower limiting part disposed between the upper limiting part and the base. The slide member has a slide arm extending slidably into the outer member, and a top seat disposed above the outer member. The coupling unit couples the angle-adjustable member to the top seat. The control member extends into the outer member, is coupled to the slide member, and cooperates with the lower limiting part to prevent impact between the display panel and a support surface.

### CROSS-REFERENCE TO RELATED APPLICATION

This application claims priority of Taiwanese application no. 094205193, filed on Apr. 4, 2005.

### BACKGROUND OF THE INVENTION

1. Field of the Invention

The invention relates to a support for a display device, more particularly to a height-adjustable support for a display device.

2. Description of the Related Art

Adjustable supports for display panels are known in art. The known adjustable supports not only permit height adjustment, but also permit adjustment of the viewing angle. Other conventional adjustable supports further permit orienting of a long axis of a display panel in a selected one of horizontal and vertical directions. When the long axis of the display panel is oriented vertically, viewing of a document page is facilitated.

However, when downward height adjustment is performed while the long axis of the display panel is oriented vertically, the conventional adjustable supports do not incorporate mechanisms that can prevent impact between the display panel and a support surface, thereby resulting in possible damage to the display panel.

### SUMMARY OF THE INVENTION

Therefore, the object of the present invention is to provide a height-adjustable support that is adapted for supporting a display panel and that is capable of overcoming the aforesaid drawback associated with the prior art.

According to the present invention, a height-adjustable support comprises a base, a telescopic unit, an angle-adjustable member, a coupling unit, and a control member.

The telescopic unit includes a hollow outer member and an inner slide member. The outer member extends upwardly from the base, and is provided with an upper limiting part disposed above the base, an inwardly projecting lower limiting part disposed between the upper limiting part and the base, and a vertical slide hole unit formed beside the upper limiting part. The slide member has at least one slide arm extending slidably into the slide hole unit in the outer member and having upper and lower arm ends disposed above and below the upper limiting part, respectively, and a top seat mounted on the upper arm end and disposed above the outer member.

The coupling unit couples the angle-adjustable member to the top seat such that the angle-adjustable member is rotatable about a horizontal axis.

The control member extends into the outer member, is coupled to the slide member, and is movable with respect to the slide member between a first state, where the lower limiting part is unable to restrict the control member such that the lower limiting part does not limit downward movement of the slide member relative to the outer member, and a second state, where the lower limiting part is able to restrict the control member such that the lower limiting part defines a lower limit of downward movement of the slide member relative to the outer member.

### BRIEF DESCRIPTION OF THE DRAWINGS

Other features and advantages of the present invention will become apparent in the following detailed description of the preferred embodiment with reference to the accompanying drawings, of which:

FIG. 1 is a rear schematic view of a display device that incorporates the preferred embodiment of a height-adjustable support according to the present invention, illustrating a height-adjustable range of a display panel when a long axis of the display panel is oriented horizontally;

FIG. 2 is a view similar to FIG. 1, but illustrating the display panel when the long axis thereof is oriented vertically;

FIG. 3 is a partly exploded perspective view of the preferred embodiment of the height-adjustable support;

FIG. 4 is an exploded perspective view to illustrate an outer member of a telescopic unit and a base of the preferred embodiment;

FIG. 5 is an exploded perspective view to illustrate an inner slide member of the telescopic unit and a control member of the preferred embodiment;

FIG. 6 is an exploded perspective view to illustrate a coupling unit, a positioning member, and a first angle-adjustable member of the preferred embodiment;

FIGS. 7 and 8 are schematic side views of the preferred embodiment, illustrating a height-adjustable range when a long axis of a display panel is oriented horizontally;

FIG. 9 is a schematic side view of the preferred embodiment, illustrating how the long axis of the display panel can be changed from the horizontal orientation to a vertical orientation; and

FIG. 10 is a schematic side view of the preferred embodiment, illustrating how downward height adjustment is limited when the long axis of the display panel is oriented vertically.

### DETAILED DESCRIPTION OF THE PREFERRED EMBODIMENT

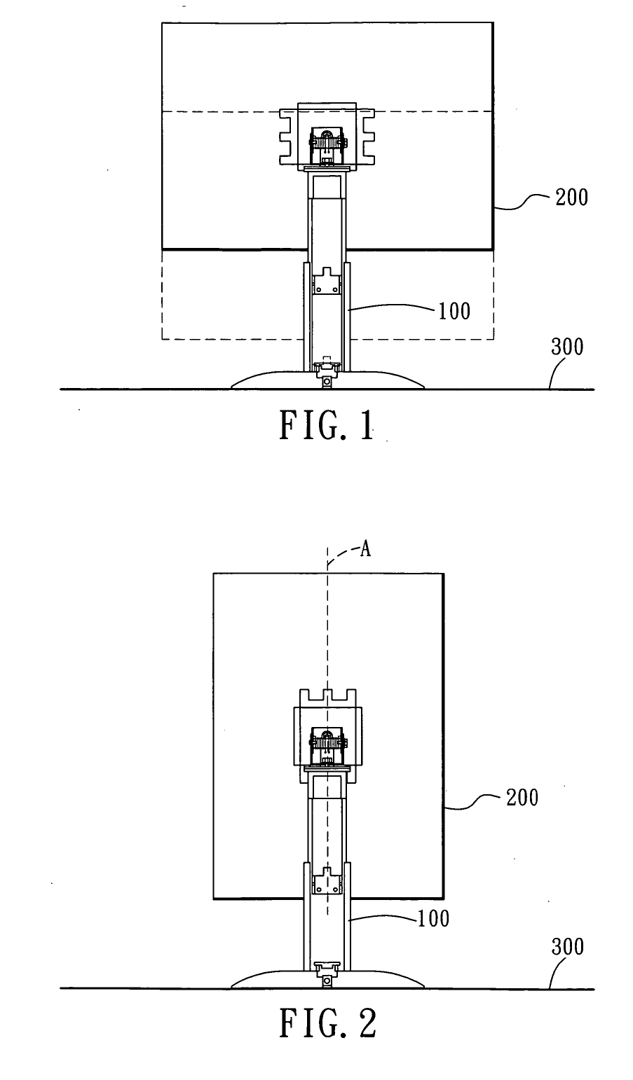

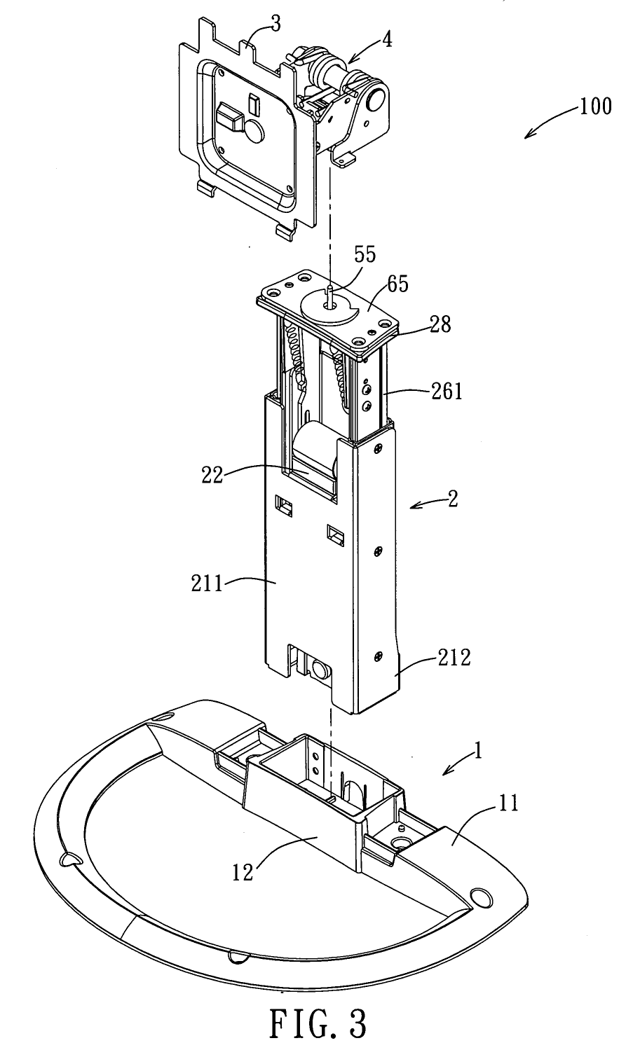

Referring to FIGS. 1 and 2, the preferred embodiment of a display device according to the present invention is shown to include a height-adjustable support 100 standing on a surface 300 (such as a table surface), and a display panel 200 mounted on the height-adjustable support 100. The display device of this embodiment is embodied in a computer monitor. However, it is evident to those skilled in the art that the display device may be configured in other embodiments as a display module of a plasma television set, a display module of a LCD television set, etc. The height-adjustable support 100 permits height adjustment of the display panel 200, as shown in FIG. 1, as well as rotational adjustment of the display panel 200 to orient a long axis (A) of the display panel 200 in a selected one of a horizontal orientation (see FIG. 1) and a vertical orientation (see FIG. 2).

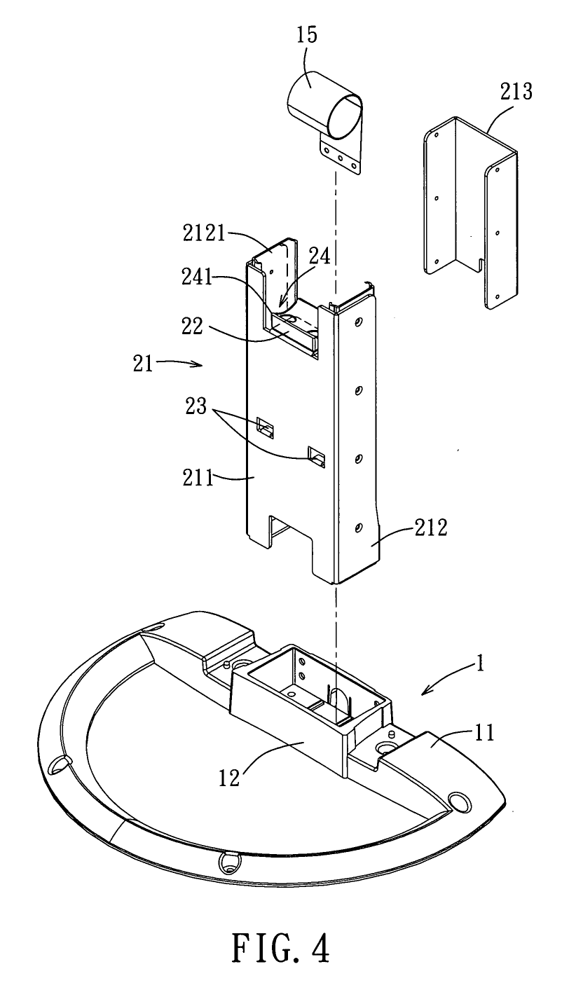

Referring to FIGS. 3 to 6, the height-adjustable support 100 comprises a base 1, a telescopic unit 2, a first angle-adjustable member 3, a coupling unit 4, and a control member 5.

The base 1 includes a main base part 11 and a hollow coupling part 12 that opens upwardly from a rear segment of the main base part 11.

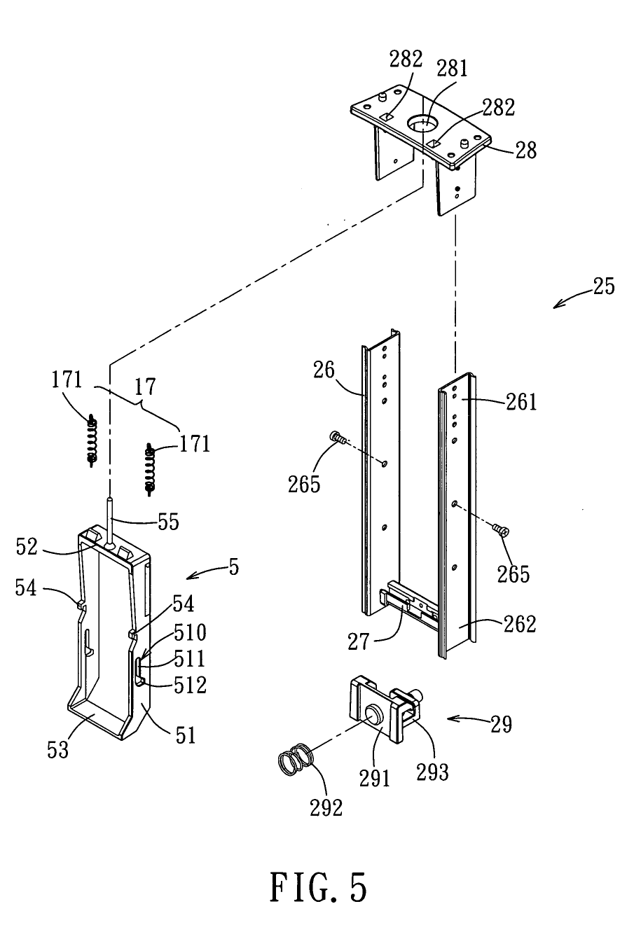

The telescopic unit 2 includes a hollow outer member 21 and an inner slide member 25. As shown in FIGS. 3 and 4, the outer member 21 is coupled to the hollow coupling part 12 so as to extend upwardly from the base 1, and is provided with an upper limiting part 22 disposed above the base 1, an inwardly projecting lower limiting part 23 disposed between the upper limiting part 22 and the base 1, and a vertical slide hole unit 24 formed beside the upper limiting part 22. The outer member 21 includes a first frame part constituted by a front wall 211 and a pair of lateral walls 212 that extend respectively and rearwardly from opposite lateral edges of the front wall 211, and a second frame part 213 having opposite lateral portions connected to the lateral walls 212 such that the outer member 21 confines an enclosed space. The lateral walls 212 are provided with vertically extending slide rails 2121 that confront each other. The front wall 211 has a top edge that is indented downwardly with respect to the lateral walls 212, and the upper limiting part 22 extends rearwardly from the top edge of the front wall 211. The slide hole unit 24 includes a pair of slide holes 241, each of which is defined by the upper limiting part 22 and a respective one of the lateral walls 212 and is in spatial communication with the slide rail 2121 of the respective one of the lateral walls 212. The lower limiting part 23 is provided on the front wall 211. In this embodiment, the upper limiting part 22 is cut and bent from the top edge of the front wall 211, whereas the lower limiting part 23 is formed on the front wall 211 by punching a pair of holes therethrough. While the upper and lower limiting parts 22, 23 are formed integrally on the outer member 21 in this embodiment, in practice, they may be fabricated separately and subsequently coupled to the outer member 21. The rearwardly projecting length of the lower limiting part 23 is shorter than that of the upper limiting part 22.

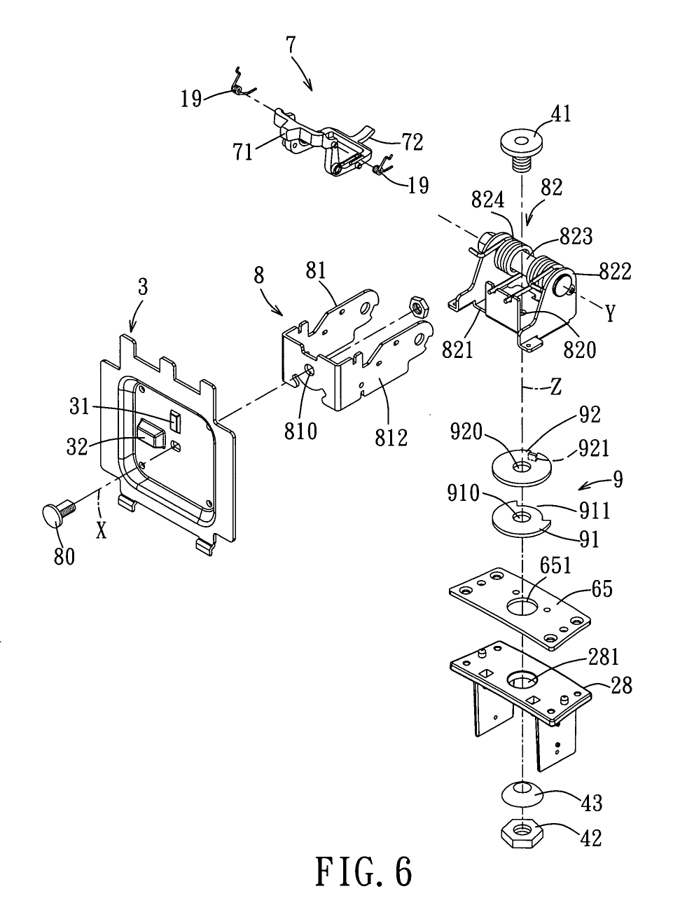

As shown in FIGS. 3 and 5, the slide member 25 has at least one slide arm 26 extending slidably into the slide hole unit 24 in the outer member 21 and having upper and lower arm ends 261, 262 disposed above and below the upper limiting part 22, respectively, and a top seat 28 mounted on the upper arm end 261, formed with a vertical hole 281 therethrough, and disposed above the outer member 21. In this embodiment, the slide member 25 includes a pair of the slide arms 26, each of which extends slidably through a respective one of the slide holes 241 and is movably confined by the slide rail 2121 of a respective one of the lateral walls 212. The top seat 28 interconnects the upper arm ends 261 of the slide arms 26. The slide member 25 further includes a bottom crossbar 27 interconnecting the lower arm ends 262 of the slide arms 26. The height-adjustable support 100 further comprises a latch unit 29 mounted in the coupling part 12 of the base 1, extending into the outer member 21, and operable so as to engage releasably the crossbar 27, thereby retaining releasably the slide member 25 at a fully retracted position (see FIG. 8) relative to the outer member 21. In this embodiment, the latch unit 29 includes a latch component 291 for engaging the crossbar 27, a biasing spring 292 for biasing the latch component 291 to engage the crossbar 27, and an operating part 293 extending from the latch component 291, accessible externally of the outer member 21 and the coupling part 12, and operable to cause the latch component 291 to disengage the crossbar 27 against biasing action of the spring 292. Since the feature of the invention does not reside in the particular configuration and operation of the latch unit 29, a detailed description of the same will be omitted herein for the sake of brevity.

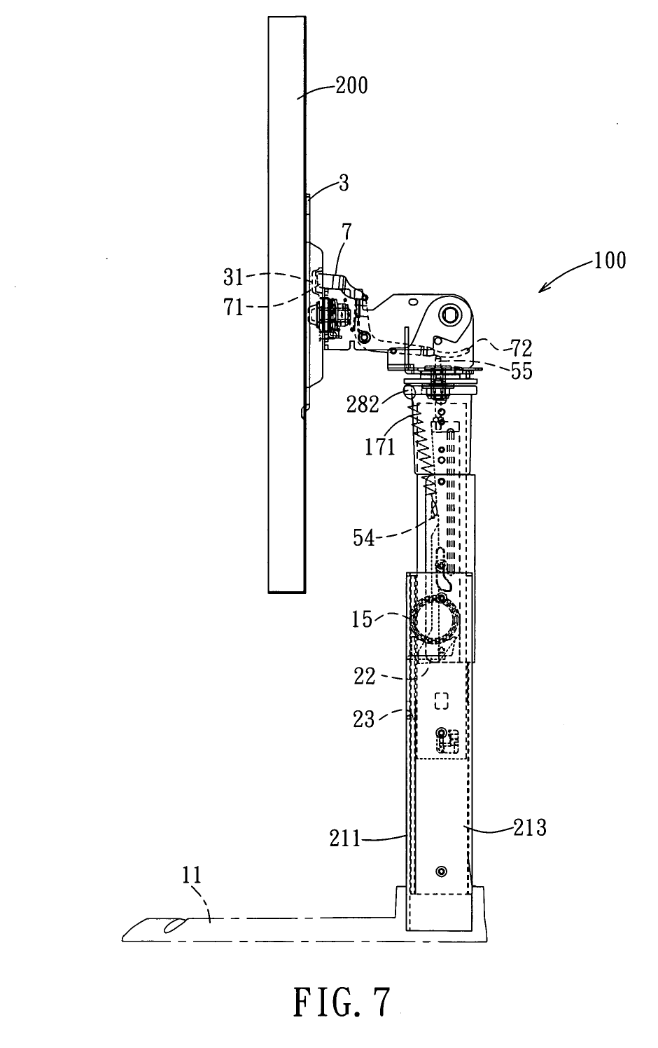

Referring to FIGS. 3 and 6, the coupling unit 4 serves to couple the first angle-adjustable member 3 to the top seat 28 such that the first angle-adjustable member 3 is rotatable about a horizontal first axis (X). The coupling unit 4 includes a second angle-adjustable member 8 and a third angle-adjustable member 9. The second angle-adjustable member 8 has the first angle-adjustable member 3 mounted rotatably thereon, and couples pivotally the first angle-adjustable member 3 to the top seat 28 such that the first angle-adjustable member 3 is further pivotable about a horizontal second axis (Y) transverse to the first axis (X). The third angle-adjustable member 9 mounts rotatably the second angle-adjustable member 8 on the top seat 28 such that the second angle-adjustable member 8, as well as the first angle-adjustable member 3, is rotatable about a vertical third axis (Z) transverse to the first and second axes (X, Y).

In this embodiment, a spacer plate 65 is disposed on top of the top seat 28 and is formed with a fastener hole 651 registered with the vertical hole 281 in the top seat 28. The second angle-adjustable member 8 is foldable, and includes a front pivotable portion 81 and a rear pivotable portion 82. The front pivotable portion 81 is U-shaped, is formed with a fastener hole 810, and has a pair of pivot arms 812. A fastener 80 extends through the first angle-adjustable member 3 and the fastener hole 810 in the second angle adjustable member 3 to secure rotatably the first angle-adjustable member 3 to the front pivotable portion 81. The rear pivotable portion 82 includes a base plate 821 disposed above the spacer plate 65 and formed with a fastener hole 820 registered with the fastener hole 651, a pair of pivot lugs 822 extending upwardly and respectively from lateral edges of the base plate 821, a pivot axle 823 extending between and rotatable relative to the pivot lugs 822 and having the pivot arms 812 of the front pivotable portion 81 coupled thereto, and a torsion spring unit 24 to resist rotation of the pivot axle 823 such that the front pivotable portion 81 can be retained at a desired angle relative to the rear pivotable portion 82 in a manner well known in the art.

The third angle-adjustable member 9 is disposed between the base plate 821 and the spacer plate 65, and includes a lower plate piece 91 and an upper plate piece 92. The lower plate piece 91 is disposed on top of the spacer plate 65, has a notched periphery 911, and is formed with a lower fastener hole 910 registered with the fastener hole 651. The upper plate piece 92 is formed with a downwardly extending tongue 921 movably confined in the notched periphery 911 of the lower plate piece 91, and is further formed with an upper fastener hole 920 registered with the lower fastener hole 910. A hollow fastener 41 extends through the holes 820, 920, 910, 650, 281, and a nut 42 engages the fastener 41, thereby securing rotatably the rear pivotable portion 82 on the top seat 28. The extent of rotation of the second angle-adjustable member 8 about the third axis (Z) can be limited by the cooperative action of the tongue 921 and the notched periphery 911. In addition, a washer 43 is disposed between the nut 42 and the top seat 28 to enhance tightness of the securing effect of the fastener 41.

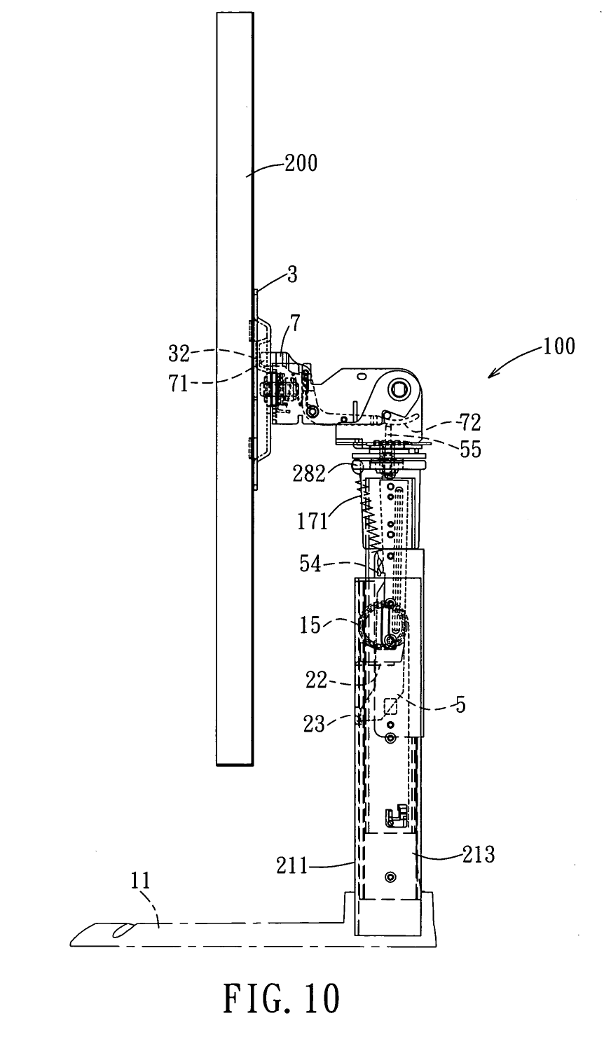

Referring again to FIGS. 3 and 5, the control member 5 extends into the outer member 21, is coupled to the slide member 25, and is movable with respect to the slide member 25 between a first state (see FIG. 8), where the lower limiting part 23 is unable to restrict the control member 5 such that the lower limiting part 23 does not limit downward movement of the slide member 25 relative to the outer member 21, and a second state (see FIG. 10), where the lower limiting part 23 is able to restrict the control member 5 such that the lower limiting part 23 defines a lower limit of downward movement of the slide member 25 relative to the outer member 21. The control member 5 includes a pair of vertical arms 51, a top plate 52, a bottom plate 53, and a press rod 55. Each of the vertical arms 51 has upper and lower ends, is coupled slidably and tiltably to a respective one of the slide arms 26, and extends through a respective one of the slide holes 241. The top plate 52 interconnects the upper ends of the vertical arms 51, is disposed above the upper limiting part 22, and is disposed under the top seat 28 of the slide member 25. The bottom plate 53 interconnects the lower ends of the vertical arms 51, and is disposed below the upper limiting part 22. The press rod 55 extends upwardly from the top plate 51 and through the hollow fastener 41 of the third angle-adjustable member 9.

In this embodiment, each of the slide arms 26 is provided with a coupling pin 265 that extends toward the respective one of the vertical arms 51. Each of the vertical arms 51 is formed with a coupling slot 510 to engage movably the coupling pin 265 on the respective one of the slide arms 26. The coupling slot 510 has an elongate upper slide part 511 and a lower tilt part 512 in spatial communication with the upper slide part 511. In the preferred embodiment, the lower tilt part 512 is wider than the upper slide part 511.

The top seat 28 is punched to form a pair of first spring-engaging parts 282. Each of the vertical arms 51 has a front edge formed with a second spring-engaging part 54. The height-adjustable support 100 further comprises a biasing unit 17 that includes a pair of extension springs 171, each of which interconnects a respective one of the first spring-engaging parts 282 of the top seat 28 and a respective one of the second spring-engaging parts 54 of the control member 5. The biasing unit 17 applies upward and forward biasing forces to the control member 5.

The press rod 55 is depressible against biasing action of the biasing unit 17 to move the control member 5 downwardly relative to the slide member 25 such that the coupling pins 265 on the slide arms 26 move from the lower tilt parts 512 into the upper slide parts 511 of the coupling slots 510 in the vertical arms 51, respectively.

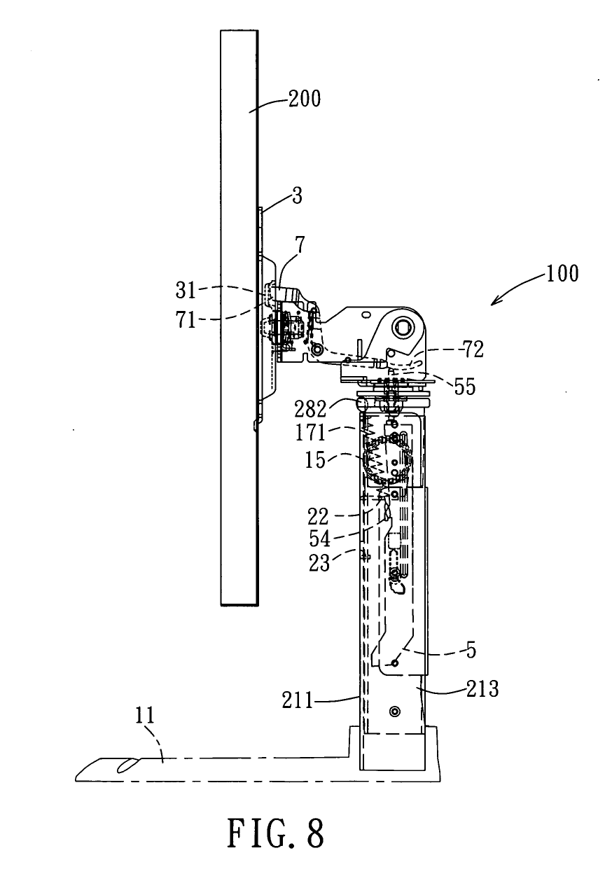

The upper slide parts 511 of the coupling slots 510 are configured to resist the forward biasing force of the biasing unit 17 such that the control member 5 is disposed in the first state, where the lower limiting part 23 is unable to restrict the bottom plate 53 of the control member 5 so that the lower limiting part 23 does not limit downward movement of the slide member 25 relative to the outer member 21, when the coupling pins 265 on the slide arms 26 extend into the upper slide parts 511 of the coupling slots 510, as shown in FIGS. 7 to 9.

The lower tilt parts 512 of the coupling slots 510 are configured to permit tilting of the control member 5 relative to the slide member 25 due to the forward biasing force of the biasing unit 17 such that the control member 5 is disposed in the second state, where the lower limiting part 23 is able to restrict the bottom plate 53 of the control member 5 so that the lower limiting part 23 defines the lower limit of downward movement of the slide member 25 relative to the outer member 21, when the coupling pins 265 on the slide arms 26 extend into the lower tilt parts 512 of the coupling slots 510, as shown in FIG. 10.

Referring again to FIG. 6, the height-adjustable support 100 further comprises a positioning member 7 having an engaging end 71 for engaging removably the first angle-adjustable member 3, and an abutting end 72 for abutting against a distal end of the press rod 55 of the control member 5. The positioning member 7 is retained pivotally between the pivot arms 812 of the front pivotable portion 81 of the second angle-adjustable member 8 of the coupling unit 4. The height-adjustable support 100 further comprises an urging unit 19 for urging the positioning member 7 to pivot such that the abutting end 72 abuts against the press rod 55 of the control member 5. In this embodiment, the urging unit 19 includes a pair of torsion springs.

The first angle-adjustable member 3 is rotatable about the first axis (X) relative to the top seat 28 between first and second angular positions, and is formed with angularly spaced apart first and second recesses 31, 32 that correspond respectively to the first and second angular positions. In this embodiment, the first and second recesses 31, 32 are angularly spaced apart by 90 degrees. When the first angle-adjustable member 3 is at the first position, the press rod 55 acts on the abutting end 72 of the positioning member 7 for causing the engaging end 71 of the positioning member 7 to engage removably the first recess 31. On the other hand, when the first angle-adjustable member 3 is at the second position, the press rod 55 acts on the abutting end 72 of the positioning member 7 for causing the engaging end 71 of the positioning member 7 to engage removably the second recess 32.

The first recess 31 is shallower than the second recess 32 such that the control member 5 is disposed at the first state when the engaging end 71 of the positioning member 7 engages the first recess 31 (as best shown in FIGS. 7 and 8), and such that the control member 5 is disposed at the second state when the engaging end 71 of the positioning member 7 engages the second recess 32 (as shown in FIG. 10).

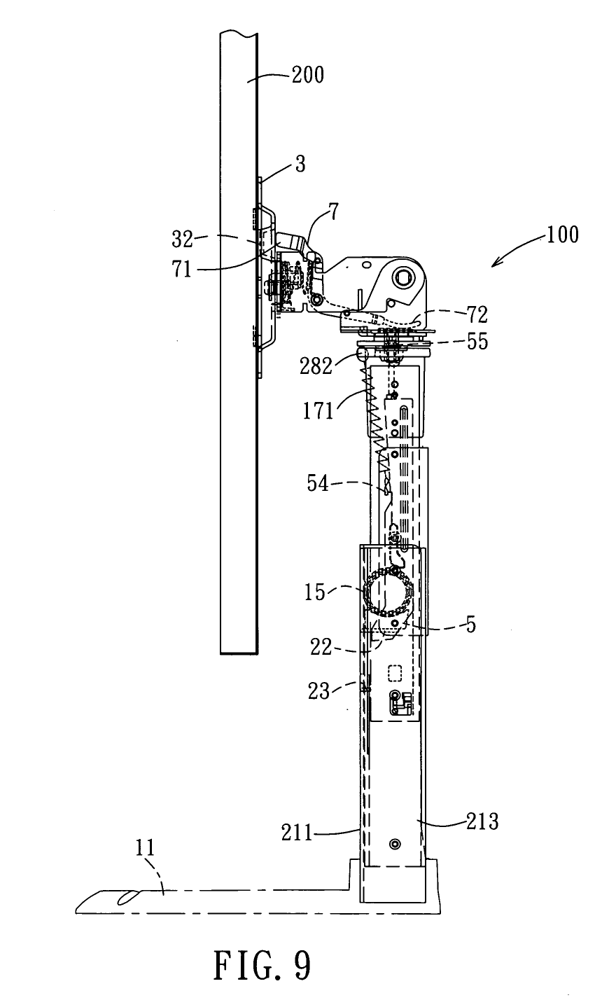

Referring to FIG. 9, when the slide member 25 is moved upwardly relative to the outer member 21 such that the bottom plate 53 of the control member 5 abuts against the upper limiting part 22 of the outer member 21, and is further moved upwardly such that the coupling pins 265 on the slide arms 26 move into upper extreme ends of the upper slide parts 511 of the coupling slots 510, the press rod 55 is retracted into the vertical hole 281 in the top seat 28, and the positioning member 7 pivots rearwardly by virtue of urging action of the urging unit 19 such that the engaging end 71 of the positioning member 7 is able to disengage from an aligned one of the first and second recesses 31, 32 in the first angle-adjustable member 3, thereby permitting rotation of the first angle-adjustable member 3 from one of the first and second angular positions to the other of the first and second angular positions.

In use, the display panel 200 is mounted on the first angle-adjustable member 3. The height-adjustable support 100 further comprises a spring member 15 (see FIG. 4) for maintaining the slide member 25 at a desired extended position relative to the outer member 21. In this embodiment, the spring member 15 is a spiral spring seated on the upper limiting part 22 and having a distal portion that extends into the outer member 21 and that is connected to the crossbar 27 of the slide member 25. The spring member 15 provides a biasing force such that an equilibrium state between the biasing force and the combined weight of the display panel 200, the angle-adjustable members 3, 8, 9, the positioning member 7, the slide member 25 and the control member 5 can be achieved so as to maintain the slide member 25 at a desired extended position relative to the outer member 21. Since the spring member 15 is known in the art, further details of the same will be omitted herein for the sake of brevity. When the display panel 200 is mounted on the first angle-adjustable member 3, the display panel 200 can be adjusted such that the long axis (A) thereof has a vertical or horizontal orientation. In addition, in view of the second angle-adjustable member 8 of the coupling unit 4, the tilt of the display panel 200 can be adjusted. Furthermore, in view of the third angle-adjustable member 9 of the coupling unit 4, the viewing angle of the display panel 200 is adjustable as well.

In operation, referring to FIGS. 1, 7 and 8, when the long axis (A) of the display panel 200 is oriented horizontally (i.e., a short axis of the display panel 200 has a vertical orientation), the press rod 55 acts on the abutting end 72 of the positioning member 7 for causing the engaging end 71 of the positioning member 7 to engage the first recess 31 such that the control member 5 is disposed at the first state. At this time, when the slide member 25 is moved upwardly relative to the outer member 21, the bottom plate 53 of the control member 5 is able to abut against the upper limiting part 22 of the outer member 21 to limit upward height adjustment of the display panel 200. Moreover, since the lower limiting part 23 is unable to restrict downward movement of the control member 5 when the control member 5 is disposed at the first state, the slide member 25 is able to move downward until the crossbar 27 engages the latch unit 29.

Referring to FIGS. 2 and 10, when the display panel 200 is adjusted such that the long axis (A) thereof is oriented vertically (i.e., the short axis of the display panel 200 has a horizontal orientation), the press rod 55 acts on the abutting end 72 of the positioning member 7 for causing the engaging end 71 of the positioning member 7 to engage the second recess 32 such that the control member 5 is disposed at the second state. At this time, while the bottom plate 53 of the control member 5 and the upper limiting part 22 of the outer member 21 can still cooperate to limit the extent of upward height adjustment of the display panel 200, the lower limiting part 23 is now able to restrict downward movement of the control member 5, thereby limiting the extent of downward height adjustment of the display panel 200. As a result, impact between the display panel 200 and the support surface 300 can be avoided in the height-adjustable support 100 of this invention when the long axis (A) of the display panel 200 is oriented vertically.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A height-adjustable support comprising:
a base;
a telescopic unit including
a hollow outer member extending upwardly from said base and provided with an upper limiting part disposed above said base, an inwardly projecting lower limiting part disposed between said upper limiting part and said base, and a vertical slide hole unit formed beside said upper limiting part, and
an inner slide member having
at least one slide arm extending slidably into said slide hole unit in said outer member and having upper and lower arm ends disposed above and below said upper limiting part, respectively, and
a top seat mounted on said upper arm end and disposed above said outer member;
a first angle-adjustable member;
a coupling unit for coupling said first angle-adjustable member to said top seat such that said first angle-adjustable member is rotatable about a horizontal first axis; and
a control member extending into said outer member, coupled to said slide member, and movable with respect to said slide member between a first state, where said lower limiting part is unable to restrict said control member such that said lower limiting part does not limit downward movement of said slide member relative to said outer member, and a second state, where said lower limiting part is able to restrict said control member such that said lower limiting part defines a lower limit of downward movement of said slide member relative to said outer member.

2. The height-adjustable support as claimed in claim 1, wherein said outer member includes a front wall and a pair of lateral walls that extend respectively and rearwardly from opposite lateral edges of said front wall,
said upper limiting part extending rearwardly from a top edge of said front wall,
said slide hole unit including a pair of slide holes, each of which is defined by said upper limiting part and a respective one of said lateral walls,
said lower limiting part being provided on said front wall.

3. The height-adjustable support as claimed in claim 2, wherein said lower limiting part is formed on said front wall by punching.

4. The height-adjustable support as claimed in claim 2, wherein said slide member includes a pair of said slide arms, each of which extends slidably through a respective one of said slide holes, said top seat interconnecting said upper arm ends of said slide arms.

5. The height-adjustable support as claimed in claim 4, wherein said slide member further includes a bottom crossbar interconnecting lower ends of said slide arms, said height-adjustable support further comprising a latch unit mounted on said base, extending into said outer member, and operable so as to engage releasably said crossbar, thereby retaining releasably said slide member at a fully retracted position relative to said outer member.

6. The height-adjustable support as claimed in claim 4, wherein said control member includes:
a pair of vertical arms, each of which is coupled slidably and tiltably to a respective one of said slide arms and extends through a respective one of said slide holes;
a top plate interconnecting upper ends of said vertical arms, disposed above said upper limiting part, and disposed under said top seat of said slide member; and
a bottom plate interconnecting lower ends of said vertical arms and disposed below said upper limiting part.

7. The height-adjustable support as claimed in claim 6, wherein:
each of said slide arms is provided with a coupling pin that extends toward the respective one of said vertical arms;
each of said vertical arms being formed with a coupling slot to engage movably said coupling pin on the respective one of said slide arms, said coupling slot having an elongate upper slide part and a lower tilt part in spatial communication with said upper slide part;
said height-adjustable support further comprising a biasing unit that interconnects said slide member and said control member and that applies upward and forward biasing forces to said control member;
said upper slide parts of said coupling slots being configured to resist the forward biasing force of said biasing unit such that said control member is disposed in the first state, where said lower limiting part is unable to restrict said bottom plate of said control member so that said lower limiting part does not limit downward movement of said slide member relative to said outer member, when said coupling pins on said slide arms extend into said upper slide parts of said coupling slots;
said lower tilt parts of said coupling slots being configured to permit tilting of said control member relative to said slide member due to the forward biasing force of said biasing unit such that said control member is disposed in the second state, where said lower limiting part is able to restrict said bottom plate of said control member so that said lower limiting part defines said lower limit of downward movement of said slide member relative to said outer member, when said coupling pins on said slide arms extend into said lower tilt parts of said coupling slots.

8. The height-adjustable support as claimed in claim 7, wherein:
said top seat is formed with a vertical hole therethrough;
said top plate of said control member having a press rod that extends through said vertical hole in said top seat;
said press rod being depressible against biasing action of said biasing unit to move said control member downwardly relative to said slide member such that said coupling pins on said slide arms move from said lower tilt parts into said upper slide parts of said coupling slots in said vertical arms, respectively.

9. The height-adjustable support as claimed in claim 8, further comprising a positioning member having an engaging end for engaging removably said first angle-adjustable member, and an abutting end for abutting against said press rod of said control member.

10. The height-adjustable support as claimed in claim 9, wherein said positioning member is connected pivotally to said coupling unit, said height-adjustable support further comprising an urging unit for urging said positioning member to pivot such that said abutting end abuts against said press rod of said control member.

11. The height-adjustable support as claimed in claim 10, wherein said first angle-adjustable member is rotatable about the first axis relative to said top seat between first and second angular positions,
said first angle-adjustable member being formed with angularly spaced apart first and second recesses that correspond respectively to the first and second angular positions,
wherein, when said first angle-adjustable member is at the first position, said press rod acts on said abutting end of said positioning member for causing said engaging end of said positioning member to engage removably said first recess,
wherein, when said first angle-adjustable member is at the second position, said press rod acts on said abutting end of said positioning member for causing said engaging end of said positioning member to engage removably said second recess.

12. The height-adjustable support as claimed in claim 11, wherein said first recess is shallower than said second recess such that said control member is disposed at the first state when said engaging end of said positioning member engages said first recess, and such that said control member is disposed at the second state when said engaging end of said positioning member engages said second recess.

13. The height-adjustable support as claimed in claim 12, wherein, when said slide member is moved upwardly relative to said outer member such that said bottom plate of said control member abuts against said upper limiting part of said outer member, and is further moved upwardly such that said coupling pins on said slide arms move into upper extreme ends of said upper slide parts of said coupling slots, said press rod is retracted into said vertical hole, and said positioning member pivots rearwardly by virtue of urging action of said urging unit such that said engaging end of said positioning member is able to disengage from an aligned one of said first and second recesses in said first angle-adjustable member, thereby permitting rotation of said first angle-adjustable member from one of the first and second angular positions to the other of the first and second angular positions.

14. The height-adjustable support as claimed in claim 1, wherein said coupling unit includes:
a second angle-adjustable member having said first angle-adjustable member mounted rotatably thereon, said second angle-adjustable member coupling pivotally said first angle-adjustable member to said top seat such that said first angle-adjustable member is further pivotable about a horizontal second axis transverse to the first axis.

15. The height-adjustable support as claimed in claim 14, wherein said coupling unit further includes:
a third angle-adjustable member for mounting rotatably said second angle-adjustable member on said top seat such that said second angle adjustable member is rotatable about a vertical third axis transverse to the first and second axes.

16. The height-adjustable support as claimed in claim 1, further comprising a spring member for maintaining said slide member at a desired extended position relative to said outer member.

17. The height-adjustable support as claimed in claim 16, wherein said spring member is a spiral spring seated on said upper limiting part and having a distal portion that extends into said outer member and that is connected to said slide member.

18. A display device comprising:
a base adapted to be provided on a support surface;
a telescopic unit including
a hollow outer member extending upwardly from said base and provided with an upper limiting part disposed above said base, an inwardly projecting lower limiting part disposed between said upper limiting part and said base, and a vertical slide hole unit formed beside said upper limiting part, and
an inner slide member having
at least one slide arm extending slidably into said slide hole unit in said outer member and having upper and lower arm ends disposed above and below said upper limiting part, respectively, and
a top seat mounted on said upper arm end and
disposed above said outer member;
an angle-adjustable member;
a display panel mounted on said angle-adjustable member and having long and short axes;
a coupling unit for coupling said angle-adjustable member to said top seat such that said angle-adjustable member and said display panel are rotatable about a horizontal axis; and
a control member extending into said outer member, coupled to said slide member, and movable with respect to said slide member between a first state, where said lower limiting part is unable to restrict said control member such that said lower limiting part does not limit downward movement of said slide member relative to said outer member, and a second state, where said lower limiting part is able to restrict said control member such that said lower limiting part defines a lower limit of downward movement of said slide member relative to said outer member;
wherein, when said control member is disposed at the second state, and the long axis of said display panel is oriented vertically, said lower limiting part and said control member can cooperate to prevent impact between said display panel and the support surface on which said base is disposed.
